(19) United States
(12) Patent Application Publication
(10) Pub. No.: US 2003/0164859 A1
(43) Pub. Date: Sep. 4, 2003

(54) Hybrid widget/layout user interface for structured information

(76) Inventor: Clark Cameron Evans, Washington, DC (US)

Correspondence Address: Clark C. Evans, 630 G St. SE, Washington, DC, 20003, US

(21) Appl. No.: 10/060,221

(22) Filed: Feb. 1, 2002

Related U.S. Application Data
(60) Provisional application No. 60/265,626, filed on Feb. 2, 2001.

(51) Int. Cl. G09G 5/00

(52) U.S. Cl. 345/792

(57) ABSTRACT

Imagine an old-style typewriter where the typist's actions affect a fixed focal area, with the paper scrolling through this region. This invention presents a similar interface for content editing where the primary window is split into three panes stacked on top of each other. The center or focus pane uses a widget-based approach such that plenty of room is available for large lists, edit areas, calendar controls, and other useful information manipulation widgets. The other two panes, one above and one below the focus pane use the layout-based approach. This maintains the user's context during data entry; layouts above and below indicate the user's position within the data structure but while the user's attention can remain focused at the central position on the screen where data editing occurs. Furthermore, by replacing the bottom or top content pane with help information, this invention provides help information directly adjacent to the widget to which it applies solving the proximity problem faced by all other approaches and it does so without content resizing or shaking the user's context. The overall result blends the strong points of the context preserving layout-based approach, the powerful editing capabilities of the widget-based approach and effective proximity-based coaching with surprisingly few drawbacks

### BACKGROUND OF THE INVENTION

This invention relates to software user interface techniques for data entry and the maintenance of structured information. More particularly, the present invention relates to a unique combination of widget-based and layout-based interface techniques which together make the user's experience both intuitive and efficient.

There are two general approaches for computer interfaces: layout-based and widget-based. Layout-based interfaces simulate printed material and are usually presented as a sequence of format objects such as characters, images, or tables. Word processors, spreadsheets, and drawing programs are examples of layout-based user interfaces. Layout-based interfaces are usually deemed intuitive since they look exactly like printed material and thus are familiar to the user. Since layout-based interfaces often dynamically resize and are usually focused on viewing, they also tend to have a fairly compact representation of information and maintain the user's context well. Layout-based interfaces work well for free-flowing data where the user determines the information's structure. However, the layout-based approach fares less well when data must be structured in a strict manner.

By contrast, widget-based interfaces mirror an abstract information structure and are presented to the user as a composition of visual interface components or widgets. Widgets include, but are not limited to text edit boxes, list boxes, date-pickers and tabular grids. Database programs, business form software, and other strictly structured applications are typically widget-based. Since widget-based interfaces are often laid out in a static design, they become familiar to a seasoned user and thus efficient to use. Furthermore, certain widgets, such as a calendar display or pick list, effectively coach data entry and offer data validation tailored to specific application requirements. Unfortunately, since these widgets are often larger than what would be needed to print a specific field value, widget-based interfaces can deviate significantly from a printed report of the same information and therefore may seem less intuitive. While layout-based interfaces are compact and maintain user context well, widget-based interfaces are more verbose and usually better at handling details.

The two general approaches above are not mutually exclusive; many prior art user interfaces take a hybrid widget/layout approach. Depending on the problem domain, each hybrid must balance several factors: (a) how to use limited display space, (b) how users maintain their context within the information structure, (c) how to navigate within the information structure, (d) how context sensitive help or coaching is provided, (e) how information is validated and error conditions reported, (f) what user interface components are used to edit given data fields, (g) how the data structured as entered is represented on paper, and (h) how effectively data input devices are used, especially reducing keystrokes or mouse movements.

Of these concerns, the integration of the context-sensitive help or coaching mechanisms with the primary interface is a critical design factor. The most common help technique is a separate help window which pops up over the content area. This technique is poor since it causes the user to switch windows between the help and the content area. Another approach is to put the help in a panel adjacent to the content area, much like a split window pane. This technique is better, but it often causes the content area to resize or scroll as the help is shown and/or dismissed. Both of these techniques have a further proximity limitation since context-sensitive help is often separated from the field object or widget where it applies. This causes significant user context switching even though both the help and the applicable content may be visible at the same time. A third technique solves this proximity limitation by using a small semi-transparent pop-up that goes away when the mouse or keyboard are used. Unfortunately, this technique achieves proximity at the expense of removing the help information from the rest of the help system where further information on the subject may be available.

For the purposes of explaining the advantages of the present invention, following are detailed descriptions of prior art user interface approaches and their shortcomings. In the prior art, various trade-offs are made between having an intuitive layout-based interface and an efficient widget-based one. However, none of these approaches offers a straightforward solution that combines the best of both interface approaches in a unified manner as does the present invention.

Printable Form. This approach is an even mix of the widget and layout approaches where user interface components are limited to those widgets which are compact, such as the single-line edit box, the multi-line edit box, and the drop-down list. This approach is used by many web browsers with HTML Forms. A scroll bar is often used to mitigate the lack of display space. Unfortunately, since the edit boxes are usually of fixed size, space is often wasted or valuable content is hidden; the latter problem can be solved by automatically resizing, but the visual effect is less than pleasing. Dropdown list boxes can also be limiting when compared to regular non-collapsing list boxes. First, they require user interaction to show or hide the list portion. Second, when expanded the list portion covers other data fields, which may cause confusion. Third, for practical purposes, drop down lists are best limited to a small number of items since scroll bars are either hard to use, or sometimes not even supported. Overall the Printable Form approach is the most straightforward compromise, but it leaves much to be desired.

Tabbed Form. This approach is a dramatic separation of the widget and layout approaches; a single printed form is broken into several window panels for editing and is made available as a whole with a secondary reporting function. In this approach, each panel is typically contained within a tab to enable switching between parts of the form. Within each of these panels there is plenty of display space so that most user interface components, such as a full list box or a calendar widget, can be used. Examples of this approach include many custom programs written using Microsoft's Visual Basic (tm). In this approach, much of the information available on the printed form resides on hidden panels during editing, requiring the user to track which information is on which panel and how each panel relates to the completed form. This approach also causes significant context switching for the user as tabs change. Having multiple panels is especially problematic when business validation rules span tabs, resulting in error messages that are not relevant to the fields currently being displayed.

Step Wizard. This is similar to the Tabbed Form, where the user is guided through a series of frames representing a portion of the underlying form in a fixed sequence. Many applications use this approach, including Microsoft Excel's Chart Wizard, which additionally has a split pane showing the chart being constructed on the right hand side of the window. However, the ability to see the chart layout while the chart wizard is in progress is more the exception than the rule. Typically the print-ready layout view of the content is not available until all steps are complete. From a programmer's perspective, the step wizard makes form-level validation easier since a user cannot move on to the next frame until all fields in the current window validates. However, this advantages comes at a steep price—the user is only allowed sequential access to the underlying data structure. This makes the approach inappropriate for general editing and manipulation.

Overlay Editing. In this approach, used by programs such as Intuit's Turbo Tax (tm), the primary interface is a screen representation which closely resembles a printout. When a field is to be edited, a single user interface component is overlaid in a window over the content area. For single-line edit box, this works well when the emergent interface element completely overlays the field's region without bleeding over into other areas. However, even in this case, problems occur when the space allotted for the field is not sufficient to hold the entered data. In this case, either the data must be limited in length, rudely truncated, or the form must flexibly resize, causing the entire form to jiggle. For multi-line text areas, list boxes, and other large widgets, the situation is much worse as the space needed to display the widget's window may cover more than just the target field. Thus, when these larger widgets are needed, they necessitate a drop-down approach triggered by the user. Drop-downs bring with them a positioning dilemma. To help the user maintain context, the emergent element should be positioned in a consistent manner, however, this is not possible since each field may appear on a different border of the display window. There are only two options: scroll the display window to make room for the user interface component or position the user interface component differently depending on the position of the field. Both of these options can be jarring to the user. A final flaw of this interface is that the alternation between flow object and interface element can be jarring as the user tabs through the form and the buttons necessary to show the drop-down part of the widget appear and disappear. Although this interface approach has places where it can work well, it is decidedly not a solution for many applications.

Stationary Editing. This is a variant of Overlay Editing used by Microsoft Excel (tm) where an additional a fixed edit area appears above or below the scrollable content region. As a field in the content region is given focus, the edit area changes to reflect the field's content. Changes to the interface element in this edit area then immediately reflect back into the content region. This edit area solves the positioning problem discussed above, but it does so at a cost of having the edit area in a very different screen region from the focus field in the content region. This poses two problems: first, a user input method for jumping between the fixed edit area and the content region must be used and, second a visual feedback mechanism is needed so that it is clear which field in the content region is being shown in the edit area. Both of these problems are solvable, but can be tedious for the user and have state transition concerns, such as what the program does when the focus field scrolls out of view.

There are numerous other interface combinations which attempt the balancing act between a layout-based and widget-based interface. All of them suffer context switching problems forcing the user to spend additional effort maintaining their context. Further, most of the alternatives strictly limit the user interface components available or have a complete separation between the editing region and the layout display. Lastly, none of the above approaches improve on the current help technology leaving the proximity limitation without solution.

### SUMMARY OF INVENTION

Imagine an old-style typewriter where the typist's actions affect a fixed focal area, with the paper scrolling through this region. This invention presents a similar interface for content editing where the primary window is split into three panes stacked on top of each other. The center or focus pane uses a widget-based approach such that plenty of room is available for large lists, edit areas, calendar controls, and other useful information manipulation widgets. The other two panes, one above and one below the focus pane use the layout-based approach. This maintains the user's context during data entry; layouts above and below indicate the user's position within the data structure but while the user's attention can remain focused at the central position on the screen where data editing occurs. Furthermore, by replacing the bottom or top content pane with help information, this invention provides help information directly adjacent to the widget to which it applies solving the proximity problem faced by all other approaches and it does so without content resizing or shaking the user's context. The overall result blends the strong points of the context preserving layout-based approach, the powerful editing capabilities of the widget-based approach and effective proximity-based coaching with surprisingly few drawbacks.

Compared with prior art, this hybrid approach excels in many aspects. Unlike the Printable Form, the choice of widgets need not be restricted based on the widget's footprint and further, since a full layout-based approach is used above and below the focus area, this content is shown in a space-efficient manner without truncating. While the present invention can use the same powerful user interface widgets as the Tabbed Form, the user is always aware of context and a separate reporting facility is not required. When compared with the Step Wizard for creating content, this invention can be used with the top pane showing the output of the user's effort and the bottom pane providing context-specific help; this provides two additional benefits, better help proximity and incremental display of the output. When compared with Overlay Editing, this invention does not restrict widget selection and avoids the irritating jiggling that occurs when a format object is transformed into its editable counterpart. And, unlike Stationary Editing, the edit region is kept in context, with the content before the focus above and the content after the focus below. Thus it is seen that the present invention overcomes difficulties where prior art approaches have failed.

### BRIEF DESCRIPTION OF DRAWINGS

FIG. 1 This drawing is a screen shot of the Xgenda editor, for creating a meeting agenda. By default, when opening an existing agenda the form displays as it would be printed. Note that borders are shown to simulate a printed page. If the page is too long to fit on one page, scroll bars appear on the right. The user may use the arrow, tab, and enter keys to move around within the form. At any time, if the press the enter key or clicks with the mouse, the editor goes into “edit mode’, with the section (row) under the mouse pointer becoming the “active” row. Let us assume that “Rod Feldsman” was clicked. In this case, the screen would changed to show FIG. 2

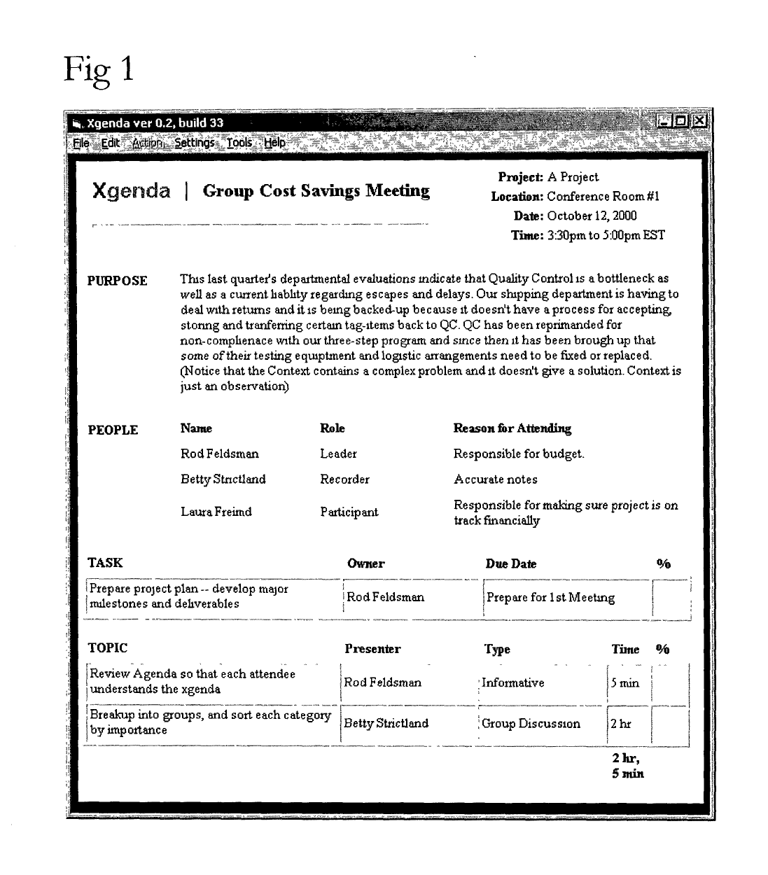

FIG. 2 In this diagram, the Xgenda program is shown. In particular: 1 The focus row shows a complete row, which is usually the transactional unit within the user's mental space. This is not possible with the “form-based” approach. 2. The person's role can now be selected with a full-scale list box. This is not possible in the “form-based” approach, without creating a pop-up list box, due to lack of space. 3. The context of the row is not lost, as a wysiwyg version of the form is shown above and below the focus row. 4. A few items not visual on the printed form may be visible 5. Tab moves to the next column (or control) within the grid without the screen changing it's shape. If the user presses the enter key or clicks on Betty Strictland with the mouse, the screen changes to show FIG. 3

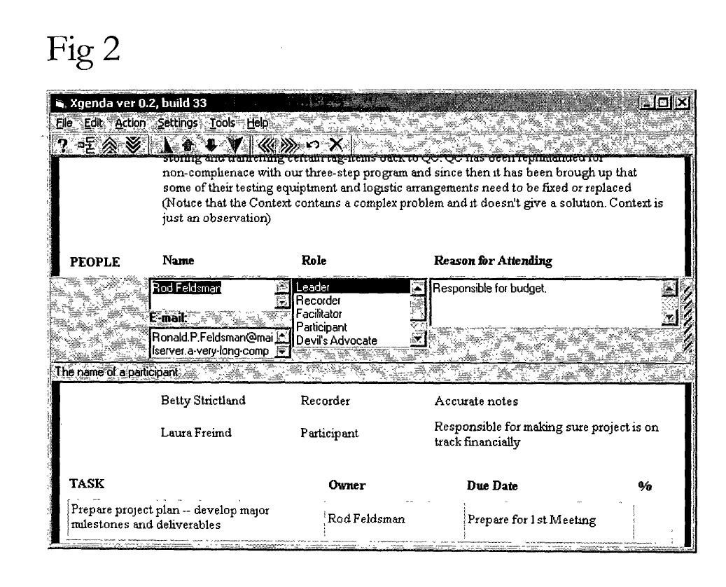

FIG. 3 In this diagram, the Xgenda program is shown. In particular: 6. The area being edited (the central edit bar) does not move. Also, the form moves “up”. This gives the appearance of the form “paper” moving through the edit area. 7. One can use the enter key to cycle through the entire form all while the part subject to change remains at the center of the screen and well within focus. 8. Having the editing area remain in center focus is completely different from both traditional techniques of form based visual interfaces. 9. When using the tab key, if focus is on the last control of the edit bar, pressing tab once again moves focus to the first control on the next row of the table being edited; or adds a new row if at the end of the table. If tab is pressed in the last control of a blank row, or enter is pressed on a blank row, then control moves to the next section. From this form, assume the user selects “Devil's Advocate” and then presses the ESC key, or clicks on a yellow area, such as to the right of Betty's Name. The screen changes to show FIG. 4

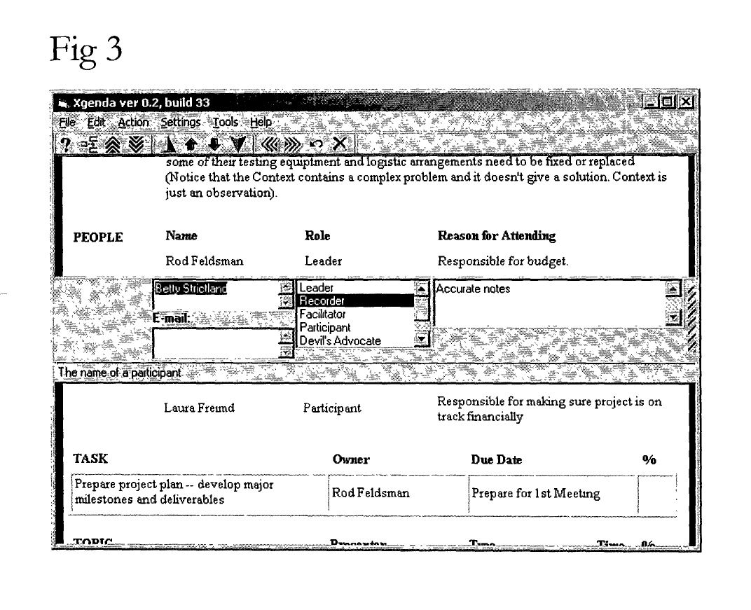

FIG. 4 In this diagram, the Xgenda program is shown. In particular: 10. Notice that the edit operation was dismissed, with the changes saved. 11. Also note that the user's context within the document is preserved, in fact the visual portion of the form starts with “some of the□” 12. Further, the mouse pointer is moved over the link which corresponds to the control which has had focus. (Not implemented well, and not shown due to the limitation of the window snapshot method used). 13. The user can then use tab key in the same manner as they had in edit mode (with the form scrolling automatically), such that the center of the screen remains in focus. (Not implemented). Alternatively, this might be taking things too far, in which case, the tab and enter key can simply move the mouse pointer (Implemented). 14. At any time, the user can navigate around with the keyboard or mouse to select another field to edit and click or press enter to begin editing again. From the this form, assume the user navigates to and presses enter on “2” or clicks on “2”. The screen changes to show FIG. 5

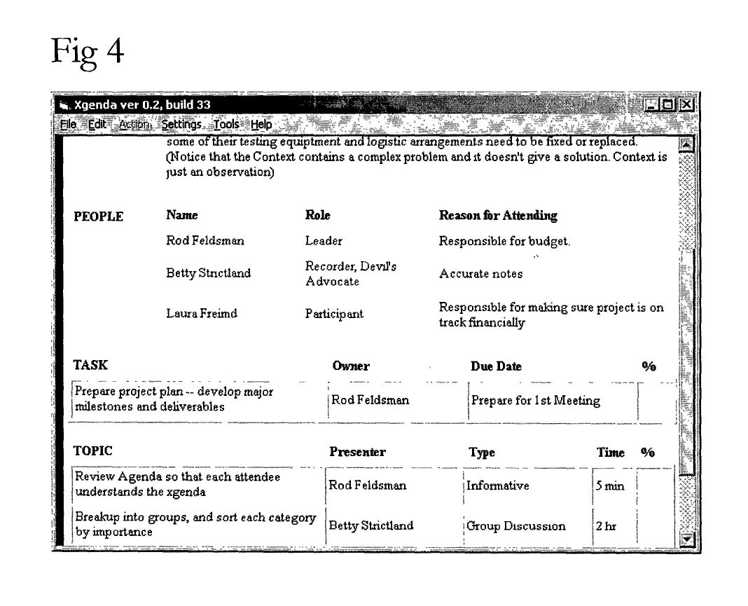

FIG. 5 In this diagram, the Xgenda program is shown. In particular: 15. Notice that the appropriate row is loaded into the edit row, the remaining part of the document is show below (with a blank space to keep the paper illusion). 16. Also note that the field selected has focus and is highlighted for easy data entry. And note that the help text is relevant and not very far from the user's context. 17. What's important to recognize is that the edit bar (the user's focal point) is not changed, instead the underlying form has moved around the edit area as appropriate. From the is form, assume the user puts the mouse down on the ribbed area to the right of the % list box, and drags downward. This allows the edit area to be moved by the user as they see fit. This edit bar can be moved up and down, even to the point where the top or bottom part of the form isn't visible. This change is shown in FIG. 6

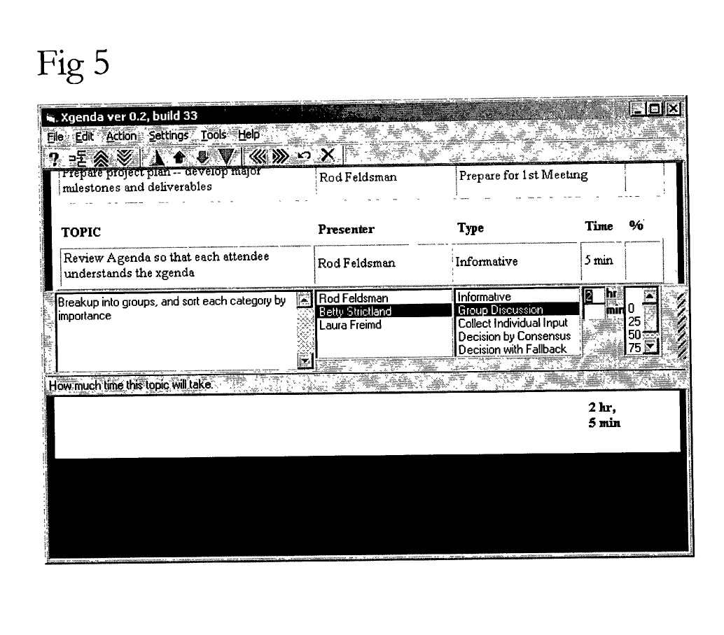

FIG. 6 In this diagram, the Xgenda program is shown. In particular: 18. As the user drags the edit area up and down, the paper moves as appropriate. 19. It is also possible that dragging this edit area would leave the paper stationary and change what is being “blow-up”, much like a magnifying glass going over paper. Dragging with the left mouse button rather than the right mouse button can do this. (Not implemented yet). 20. Note that neither of the two state-of the art approaches allows functionality even close to this. From the previous form, the navigation bar on top, and the help bar can obviously be turned off. This creates the visual shown in FIG. 7

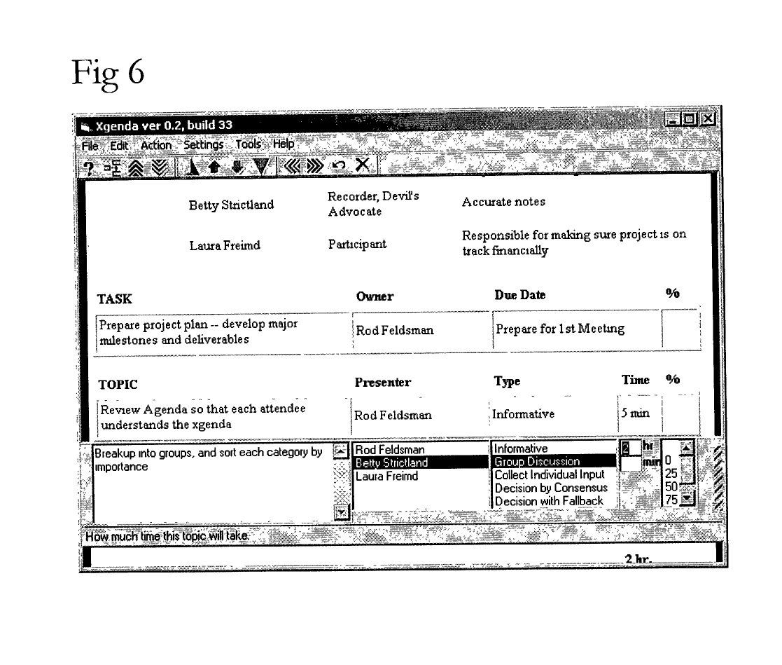

FIG. 7 In this diagram, the Xgenda program is shown. In particular: 21. There is very little difference between this view and the print-preview view. Once again, this has the advantage of the “form-based” editors without the contextual problems of the “control-based” editors. 22. At any time, function keys can be used to navigate. F5 moves to the previous section (in this case PURPOSE), and F8 moves to the first row of the next section (in this case TASK). F6 moves to the next row, while F7 moves to the previous row. Likewise, F2 inserts a row, and F10 deletes a row. The function keys take on the same sequence as the navigation bar above, so that the correspondence can be easily grocked. From the previous form, pressing F1 brings up a “wizard” area. In many circumstances, the user may be unfamiliar with the form to such a point where detailed, field level, help is required. Go to FIG. 8

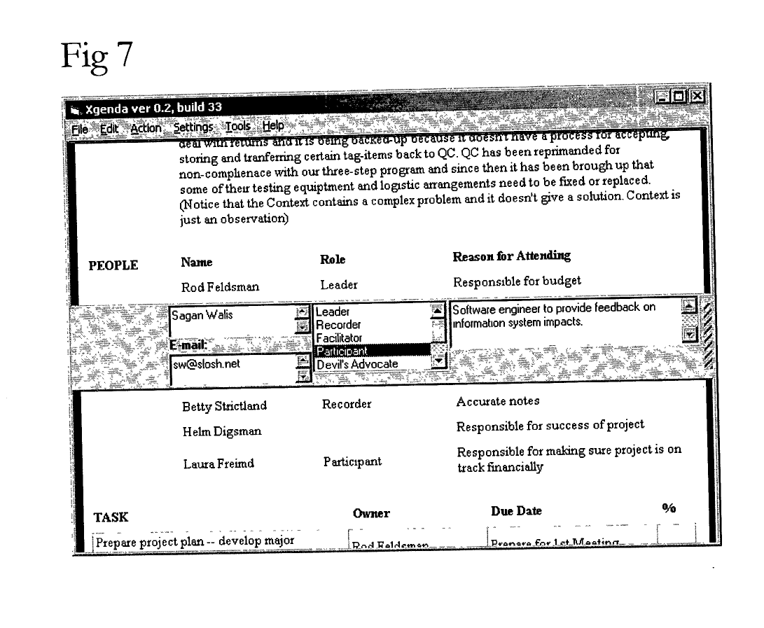

FIG. 8 In this diagram, the Xgenda program is shown. In particular: 23. F1 toggles the detailed help, without interrupting the user's context since they can see what is before them, and without taking focus away from what they are working on, here the edit focus remains on the text box containing Sagan Walis. 24. In the traditional “control-based” interface, the help is a usually a pop-up which both disrupts the user's context and also interrupts their typing. In this interface toggling F1 between the help and the following text occurs without a loss of focus. 25. In the modern “form-based” approaches, they often divide the screen in half, or provide a wizard area above. The problem with this approach is that there is contextual information between the control being edited and the help itself, and this contextual information (the form above/below the edit area) is distracting when the user is tryig to focus on the content for a given field. This type of interface has several limitations. For the most part, it can only handle a form that is a sequence of tables, given the degenerate table having one row and one column. In the FIG. 9, it is shown how a limited support for hierarchies can be implemented.

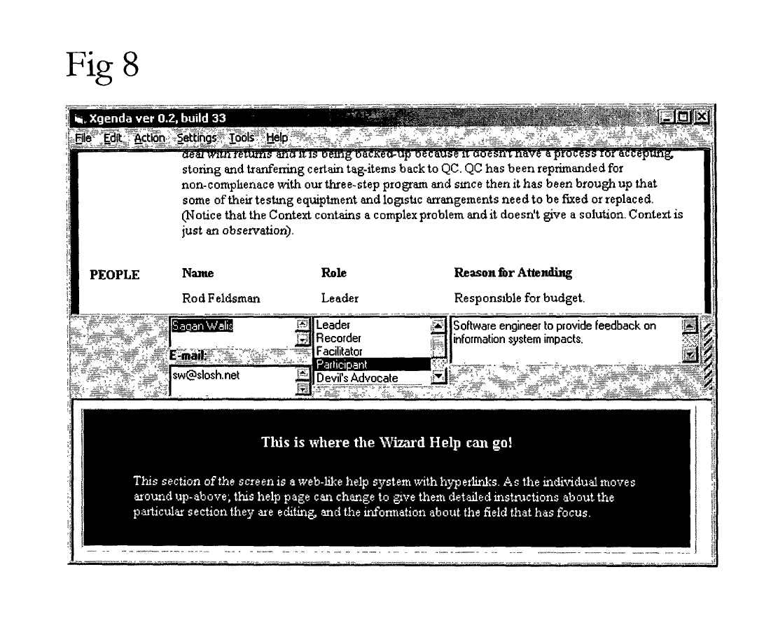

FIG. 9 In this diagram, the Xgenda program is shown. In particular: 26. Here the topic “Brainstorm□” has two children., “Sort□” and “Organize□”. Simple indentation is used, although pictures may be a nice visual addition (or distraction). 27. F9 and F10 can be used to indent and un-indent a given block. And F3 and F4 can be used to swap a row up or down. Of course 28. Many of the “form-based” approaches I've seen do not do a good job at allowing rows to be moved around, while the “control-based’ ones typically have one grid(section) per page. And this is usually a great waster of space. 29. If you notice in the navigate bar, the fourth button over, Swap Down, is enabled. It is enabled since there is an adjacent row that it can swap with. By pressing the swap down button, you can see that not just one row was swapped. Swap works within the current indentation level, thus “Sort□” and “Organize.” were treated as a part-of the “Brainstorm□” Goto diagram FIG. 10

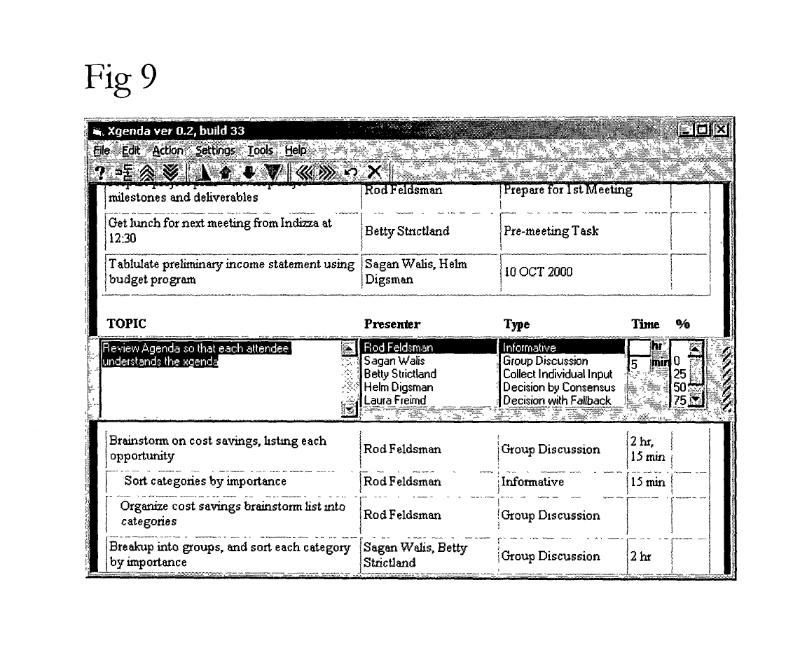

FIG. 10 In this diagram, the Xgenda program is shown. In particular: 30. Note here, that both swap up and swap down are enabled, this is because the current row has both a previous and a following sibling. 31. Most “form-based” interfaces tend to do this poorly, while most control-based interfaces handle hierarchies very well, but lack the contextual information and tend to jar the user. 32. As seen on the screen, there isn't a visual clue if the current row is indented or not; this remains to be implemented. It merely involves moving the first edit box in to the current indentation level. It is possible in this interface for one of the tables to define the allowable values in the list box of another table's field. Also, changing the value in once place can be percolated. For instance, in this prototype, the user could change “Rod” to “Jake”, and the tasks and topics that Rod was the owner/presenter are now changed to reflect Jake as a replacement. Thus, values can be handled by position and lookups can be done in the background for the remainder of the document. Go to diagram FIG. 11

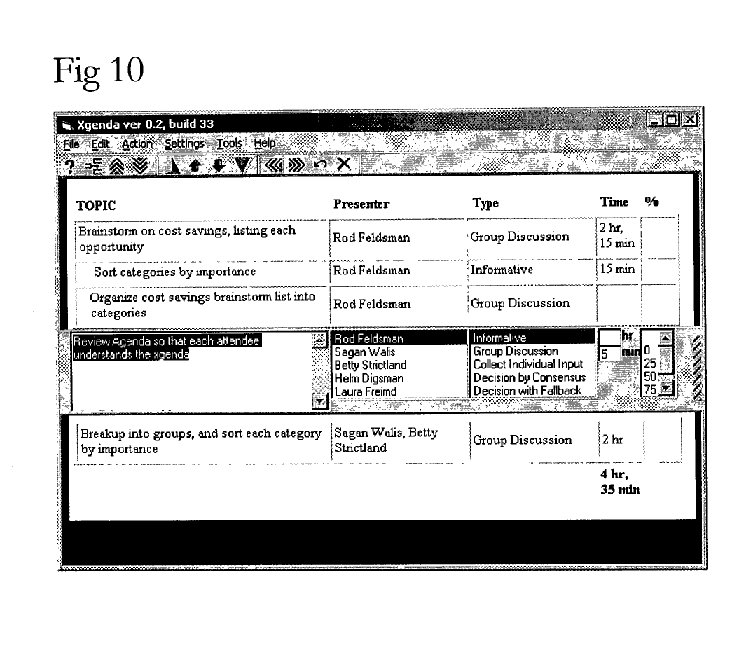

FIG. 11 In this diagram, the Xgenda program is shown. In particular: 33. It also goes without saying that these list boxes could be populated from a database, another form, or many other dynamic methods (the prototype has them hard-coded with the Owner/Presenter as the sole exception. 34. Furthermore, it is possible to have multiple optional sections. This is not implemented, but the settings menu could easily be altered to make the task section optional. 35. Also, one could have one table be used to specify additional document fragments (one or more tables) later on in the document. This would be difficult to do in a control-based form. It would be possible in a form-based version, but not so easy. This document is stored internally as XML exposed through a DOM interf ace.

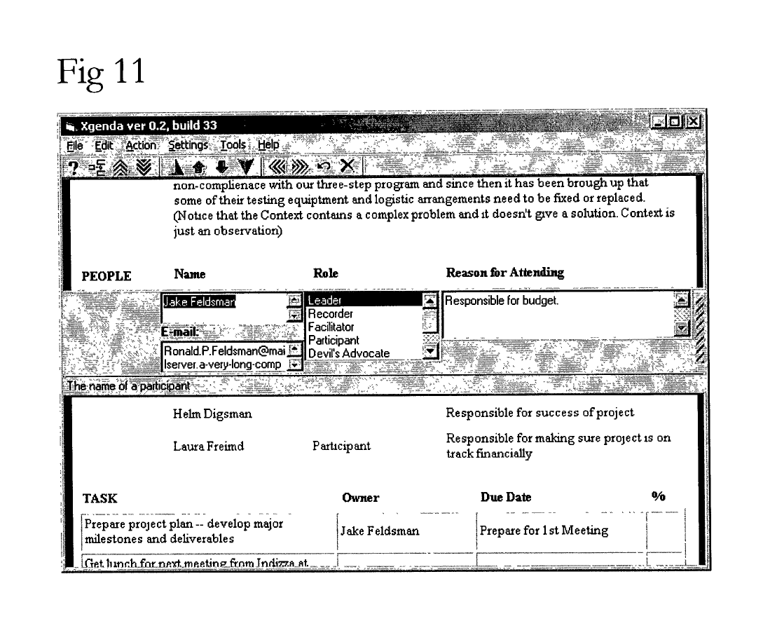

FIG. 12 This is the internal process diagram for the Xgenda application.

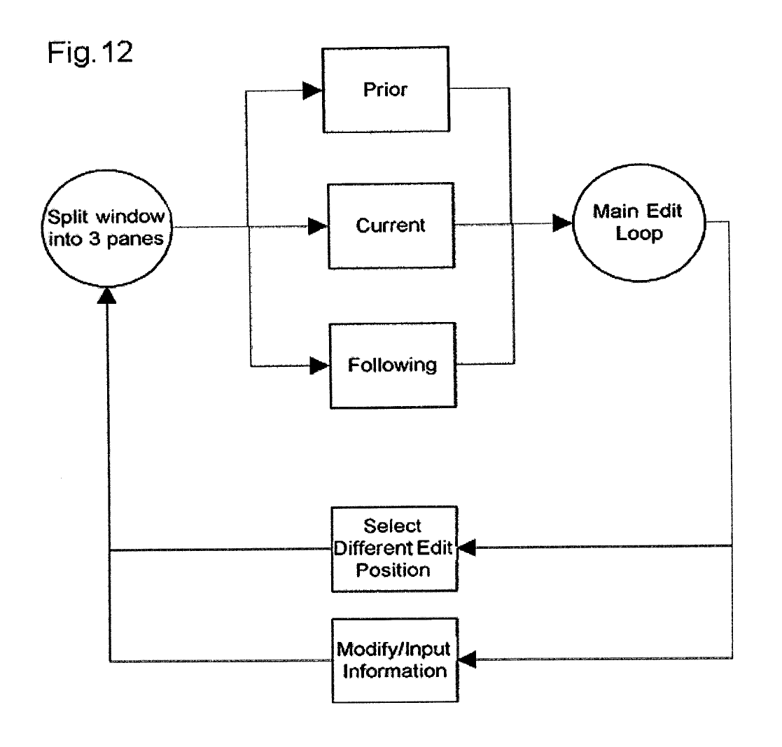

### DETAILED DESCRIPTION

The present invention was conceived and then reduced to practice in January and February of 2002. It emerged initially as a user interface for the creation and modification of a meeting agenda. During the rapid prototype phase, each of the prior art approaches described above were examined and rejected due to requirements of our product: first, it had to be easy to use for a novice who has never used the tool before and second, it had to be efficient for an experienced individual who wanted to produce an agenda rapidly. We realized that providing friendly, context-sensitive coaching and showing incremental results were critical aspects of the program, and hence most state-of-the-art approaches were rejected. Another requirement of the system was that it were to be web compatible so that agendas can be posted to an organization's intranet and viewable through modern web browsers.

The data structure of this agenda creator is an extensible Markup Language (“XML”) file. The system uses XML Style Sheet Transformations (“XSLT”) to transform the XML into an Hyper Text Markup Language (“HTML”) for the layout-based frames. At the time of creation, XML FORMS (“XFORM”) was considered as a language to describe the central frame, but this was rejected due to the specification being slightly immature. Instead, the layout of the widget-based central frame was essentially hard-coded based on the agenda application requirements, however, a generic implementation of the central form area has lots of prior art. XML, HTML, XSLT, and XFORM are all specifications published by the world wide web consortium (“W3C”).

The content model for the agenda application is broken down into a hierarchical abstraction. Each document consists of one or more segments. Each segment consists of one or more blocks and one or more fields. Each block, which can be visualized as a row, contains one or more cells, each of which is associated with a field as defined by the segment in which it is found. While other underlying information models are probably possible and would be obvious given a particular application, this information model is known to work well for the agenda applications and will most likely work for many other applications. For some applications, where the underlying information structure is large, multiple sections using the tab metaphor were envisioned but not implemented. Also, a generic inter-document linking would be possible, supporting something like the W3C's XML Link (“XLINK”) recommendation.

Once the layout-based vs. widget-based interface dichotomy was understood, the primary implementation problem became how to generate the three panels from a single information source. To this end, the application used a special XSLT transformation which took three arguments: the segment and block to be shown in the focus panel and which HTML to generate, the full layout representation, the representation of the content before the focus block or the content after the focus block. In the February 2001 version of application, this XSLT style-sheet was hard-coded to be application specific, however, a preferred approach would be more application independent. For example, the necessary transform information could be given as a cross between a XML schema and a group of XSL fragments for converting sub-parts of the document into HTML/PDF for the top and bottom panels, or into XFORM or some other form description language for the focus panels. Clearly, this splitting behavior is not limited to an XML data source or HTML/XFORM for the layout-based and widget-based panels, other equivalent approaches such as using database source or dynamically generated GUI code would be clearly obvious from knowledge of this invention.

Another challenging aspect of this interface was synchronizing the bottom and top layout-based panes with the form-based pane in the center. This was done by fixing the column widths for the HTML table and working out a ratio so that the appropriate column widgets would share this same sizing constraint. This could be improved in a later version of the application by using a modification of standard table formatting algorithms as found in most browser applications. This would enable the interface to take full advantage of the layout sizing advantages without arbitrary fixed column width restrictions. Alternatively, if the layout-based version of the information differed so substantially from the widget-based representation, then the break could be more dramatic, perhaps by showing specific rows in a more traditional label/edit pattern. Regardless, there are numerous opportunities for improving the prototype which are fairly obvious at this point.

Linking a full-fledged help pane in the prototype application was not done, although this is very straightforward using industry standard techniques. As the focus block is changed to other blocks or sections, the help would change appropriately. Furthermore, if the focus block is split into multiple columns, it is clear that one may want to split the help frame in the same manner so that the help for each field is directly adjacent to the help material.

The technique of replacing one of the two content panels with an alternative tool such as a help pane could be made more generic to support other types of in-place mechanisms to help the user. For example, sometimes a list box's choices are defined by a third screen. It is clear that this lower pane could be modified so that additional functionality specific to a given widget could be shown here without disrupting the user's context. Or, in the rare case where the widget is just too big to fit in the focus panel, the entire lower panel could be used for such an extended widget; a find file dialog, widget specific spell checker, or color wheel comes to mind. The advantage of using the lower pane instead of a pop-up is clear; the user's context and keyboard focus is not interrupted as it is in other prior art. In general, it should be noted that this technique does not prevent other state of the art user interface techniques such as menus, pop-up menus, tabs, mouse-over help, hierarchical navigation frames, etc.

Navigation techniques for this interface are especially important. In the layout view, all editable cells can become links which load the block containing the selected cell into the widget-based frame and adjusting the top and bottom layout frames appropriately. Keyboard navigation similar to how spreadsheets was also implemented in the prototype, where tab key moves between fields, loading the next or previous block in the document if focus runs off the end of the edit block. Other functions for skipping to the next and previous section would be implemented. The escape key was defined so that all of the sub-frames were cleared and a single print-preview layout was shown of the document under construction. Clicking anywhere in this layout then splits the frame into the three parts where the cell clicked is loaded into the widget-based frame. A keyboard interface for the single layout window was much harder to implement, but this was due to the amount of control provided by the tools used; with better tools the keyboard navigation would have been more fluid.

During the patent search there is one application interface that seemed to come close enough to this invention so as to deserve specific mention. In Intuit's Quicken product, the check register uses a typical grid widget. Each row of this grid contains several other widgets such as pop-up calendar, and edit boxes. This much is contained in the description of the prior art enumeration previously described. However, this particular interface has a “Show Split” option which seems to split the content into a panel above, a panel below, and an edit panel. Unfortunately, this is not what is going on. The additional area which is introduced into the grid contains only additional information which is summarized in the row itself. The additional area is not used to provide additional room for widgets, such as the comment edit-box or the date widget, as is the intent with the current invention. Furthermore, the grid which contains this inserted area is not a true layout, since comments entered in the edit area which do not fit into the grid's shape is truncated, as described in Printable Form. Of course, nothing prevents the current invention from showing detail which is not shown in a print layout, such as the e-mail field in the sample screen shot.

As an internet program there are numerous other aspects of this interface which become clear. First, one could write a web browser add-in or modify a web browser to provide this functionality. Second, the splitting and displaying could be carried out on a remote host. Third, when entering a section or block, section or row level record locking could be implemented based on a particular portion of the content being shown in the widget-based central focus panel. Fourth, this technique is not limited to XML, but could be used with any information format or with interaction to a database using a protocol like JDBC or ODBC. Fifth, the techniques described are not limited to Visual Basic or the specific tools used to construct the prototype.

Program Listing Deposit

[Insert program here]

[image]

[image]

[image]

[image]

[image]

[image]

[image]

[image]

[image]

[image]

[image]

[image]

[image]

[image]

[image]

[image]

[image]

[image]

[image]

[image]

1. A user interface comprising:
(a) structured information whereupon the information is dynamically partitioned into three groups (“prior”, “current”, and “subsequent”); and
(b) two or more window panes:
(i) exactly one window pane comprising one or more user interface widgets used to enter or modify the portion of the information in the current partition (“focus panel”); and
(ii) at least one other window pane which displays a print layout representation of the information in the prior or subsequent partitions (“content panel”)

2. A help system comprising:
(a) structured information whereupon the information is dynamically partitioned into at least three groups:
(i) selected
(ii) non-selected
(iii) help; and
(b) two or more window panes:
(i) exactly one window pane where some or all of the information in the help partition can be displayed and interacted with (“help pane”); and
(ii) exactly one window pane comprising one or more user interface widgets used to enter or modify the portion of the information in the selected partition (“focus panel”); and
(c) a mechanism for placing the help panel along a line directly adjacent to the focus panel such that the focus panel does not contain the help panel; and
(d) a mechanism to show and hide the help panel where
(i) the show mechanism can displace or hide the focus panel to make room for the help panel
(ii) the hide mechanism returns the focus panel to its relative position prior to the help panel being invoked by the show mechanism
(e) a mechanism by which the contents of the help panel dynamically change based on the context of the widget within the focus panel
(f) a mechanism by which the contents of the help panel dynamically change based on interaction within the help panel itself

3. A user interface as described in claim 1 and
(a) a help system where standard help content can be placed adjacent the user interface in a separate pane;

5. A user interface as described in claim 1 adding one or more of the following:
(c) a method for performing one or more of the following operations:
(i) adding additional current information; or
(ii) changing which information is current and which information is prior or subsequent.
(d) where the relative position of the focus panel stays constant
(e) where information can be partioned by the following:
(i) row, column, or instance of text or graphic
(ii) keyboard or mouse or method of pointer navigation
(iii) by any application-determined method
(f) where hidden information can be added such that
(i) the hidden information is displayed in a field or widget within the focus panel
(ii) the hidden information can be shown or hidden within the focus panel
(iii) the hidden information can contain links or attachments to external objects
(g) where the widgets within the focus panel can contain, but are not limited to, one or more of the following:
(i) links or attachments to external objects
(ii) calculated fields
(iii) standard form objects such as radio buttons jump menus, list boxes, text fields, check boxes, multiple select lists, image field hidden field, buttons
(v) functions which execute external objects
(vi) additional panes containing one or more widgets that can be shown or hidden
(vii) dynamically changing widgets or content
(h) where the relative position of the focus panel can be adjusted
(i) where the layout of the focus panel changes based on
(i) input from external objects
(ii) interaction within the focus panel itself
(iii) input from other panes within the application
(iv) input from other applications

6. A user interface as described in claim 1 wherein the information in the content panel is described in html, and where the information is split by XSLT transform

7. A user interface as described in claim 2 and one or more of the following:
(a) a step through process in the help panel which can modify, add, or delete content in the focus panel
(b) a system whereby the user can move between the help panel and the focus panel

10. A user interface for a computerized system comprising:
(a) a memory which is able to store structured information partitioned into three categories: prior, current, and hidden; and
(b) a display operatively connected to said memory for presenting said information to a human operator, said display comprising a plurality of regions or window panes; and
(c) a focus region of said display area which maintains a relatively constant size and position within the display area and which provides a means for said operator to add additional information or modify/delete said information from said current partition of said memory; and
(c) a layout region of said display, adjacent to the focus region, which provides a means for viewing a representation of a portion of said information from said prior partition; and
(d) a selection means whereby said operator can cause said information to be re-partitioned;
whereby a programmer can design said layout region to maximize presentation clarity and can design said focus to maximilze editing functionality; and whereby said information is created from or moves into said focus region for editing by said operator and said layout region provides contextual feedback to the operator.

11. The user interface of claim C10, further including:
(a) an additional memory partition: subsequent; and
(b) an additional region, bottom, adjacent to said focus region, for displaying a represenation of said information from the subsequent partition;
whereby the user's context is enhanced by showing information from both said prior and said subsequent partitions while editing information from said current partition.

12. The user interface of claim C10, further including:
(a) an additional memory partition for storing help information pertaining to information stored in said prior, hidden, and current paritions; and
(b) an additional region, adjacent to said focus region; where said help is displayed in a manner sensitive to the content of said current partition;
whereby the user is provided with both a display of said prior information and also said help information relevant to said current information in said focus region.

13. The user interface of claim C11, further including:
(a) an additional memory partition for storing help information pertaining to information stored in said prior, hidden, and current paritions; and
(b) a switching means where by said bottom region can alternatively display said help information sensitive to the content of said current partition in lieu of displaying a representation of information from said subsequent partition;
whereby the user is provided with both a display of said prior information and either said subsequent information or said help information while editing information said current information in said focus region.

14. The user interface in claim C10, restricted so that:
(a) said prior, hidden, and subsequent partitions are stored in a manner consistent with XML data; and
(b) said layout partition is displayed using an HTML layout tool or browser;
(c) said focus partition consists of one or more standard user interface widgets such as list boxes, text edit areas, radio buttons;

15. The user interface in claim C10:
(a) restricted so that said focus and layout regions are of a fixed size and position instead of adjusting to the needs of content;
whereby said operator is not jarred with automatic screen resizes.

16. The user interface in claim C11, whereby:
(a) said information in said hidden, current, and prior partitions are ordered;
(b) said prior partition contains only information which comes before information in the current partition;
whereby said operator is able to view and edit a sequential structure such as a document or form.

17. The user interface in claim C16, whereby:
(a) said layout partition shows a representation of a subset of said prior partition which is closest to said current information;
whereby said operator is able to immediately see information recently entered or edited above said focus region in said layout region.

18. The user interface in claim C10, whereby:
(a) said layout partition emulates a peice of paper;
whereby a typewriter metaphor is used for the interface presented to said operator.
